(19) United States
(12) Patent Application Publication
(10) Pub. No.: US 2025/0326124 A1
(43) Pub. Date: Oct. 23, 2025

(54) Robot System and Calibration Method

(71) Applicant: ABB Schweiz AG, Baden (CH)

(72) Inventors: Tobias Berninger, Türkenfeld (DE); Richard Roberts, Gilching (DE)

(73) Assignee: ABB Schweiz AG, Baden (CH)

(21) Appl. No.: 19/256,504

(22) Filed: Jul. 1, 2025

Related U.S. Application Data
(63) Continuation of application No. PCT/EP2023/050029, filed on Jan. 2, 2023.

(51) Int. Cl. B25J 9/16; B25J 13/08

(52) U.S. Cl. CPC B25J 9/1692; B25J 9/1697; B25J 13/089

(57) ABSTRACT

A robot system includes a robot, a controller, and a sensor. The robot 1) comprises links connected to one another by joints. The sensor comprises an optical sensor portion arranged to sense displacement of one of the links and an evaluation portion for deriving velocity information from image data output by the sensor portion. The controller calculates an expected position of a reference point on one of the links based on rotation angles associated with the joints and on a vector of intrinsic parameters of the robot, controls movement of the reference point along a predetermined path so that the expected position varies with a predetermined velocity, compares a velocity measured by the sensor during movement to the predetermined velocity, and minimizes a deviation between the measured and predetermined velocities by varying the vector of intrinsic parameters.

### CROSS-REFERENCE TO RELATED APPLICATIONS

The instant application claims priority to International Patent Application No. PCT/EP2023/050029, filed Jan. 2, 2023, which is incorporated herein in its entirety by reference.

### FIELD OF THE DISCLOSURE

The present disclosure generally to a robot system comprising an articulated robot and its controller, and to a method for calibrating an articulated robot.

### BACKGROUND OF THE INVENTION

Robot calibration is a common problem in robotics where kinematic parameters used for trajectory planning do not match with the true kinematics of the robot, i.e. in which manufacturing tolerances, elasticity under load and other external influences cause dimensions of robot links—or rather, to be exact, distances between joint axes at opposite ends of the links—to differ from specified values, or where imperfections of a reduction gear used in a joint causes the rotation speed of the joint to fluctuate around a target value output by the controller, so that the true position of a reference point of the robot in space deviates from a position that would be expected based on rated dimensions of the robot's links and target angles that have been set for the robot's joints by a controller. Most common calibration methods are based on measurements of the actual end effector position of the robot using a laser tracker, laser interferometry, camera systems, string pull devices, or any other kind of distance sensors, and involve an optimization of the kinematic parameters of the robot based on the results of these measurements.

Residual inaccuracies that remain after calibration can be compensated by using a camera that moves along with the robot and provides an image of a target the robot shall reach. Based on the position of the target in the image, the position of the robot can be controlled in a closed loop. The faster the robot is moving, the higher the frame rate of the camera must be.

EP 3 730 256 A1 proposes to overcome this problem by using an event-based light sensor attached to a robot for detecting an optical flow. The event-based light sensor must be operative whenever the robot is moving, and evaluating its data requires substantial computing power.

### BRIEF SUMMARY OF THE INVENTION

The present disclosure generally describes a robot system and a calibrating method for it that would allow the movement of the robot to be controlled with high precision in an open loop. To this end, the present disclosure describes a robot system comprising an articulated robot, a controller and an optical flow sensor, the articulated robot comprising a plurality of links connected to one another by rotary joints, the optical flow sensor comprising an optical sensor portion arranged to sense displacement of one of the links and an evaluation portion for deriving velocity information from image data output by the sensor portion, the controller being adapted to calculate an expected position of a reference point on one of said links based on target rotation angles associated to the joints and on a vector of intrinsic parameters of the robot, to control movement of said reference point along a predetermined path so that the expected position varies with a predetermined velocity, to compare a velocity measured by said optical flow sensor during said movement to said predetermined velocity, and to minimize a deviation between the measured and predetermined velocities by varying the vector of intrinsic parameters.

### BRIEF DESCRIPTION OF THE SEVERAL VIEWS OF THE DRAWING(S)

FIG. 1 is a block diagram of a robotic system in accordance with the disclosure.

FIG. 2 is a perspective view of the articulated robot arm of the system of FIG. 1.

FIG. 3 is a cross section of a harmonic drive gear in accordance with the disclosure.

### DETAILED DESCRIPTION OF THE INVENTION

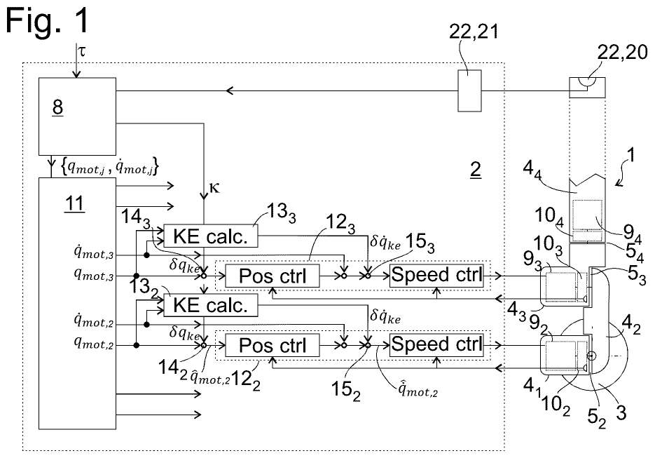

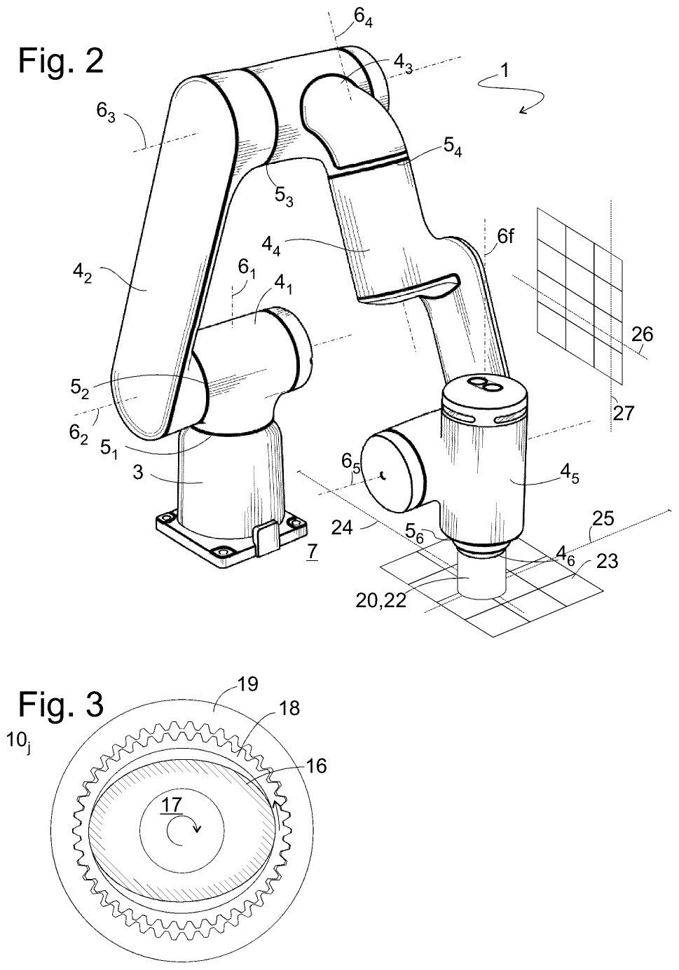

FIG. 1 is a block diagram of a robot system comprising an articulated robot arm 1 and a controller 2. The robot arm 1, shown in more detail in FIG. 2, has a stationary base 3 fixed to a horizontal support 7, such as a tabletop or a workshop floor, and a plurality of links 4ⱼ, j=1 . . . 6 rotatably connected to each other and to the base 3 by joints 5ⱼ. The joint 5₅ connecting links 4₄ and 4₅ is concealed behind link 4₅. Each joint 5ⱼ enables a rotation of the link 4ⱼ on its distal side by an axis 6ⱼ. Axis 6₁ is vertical, axes 6₂ and 6₃ are horizontal; the orientations of the other axes vary. Each joint 5ⱼ has a motor associated to it for driving its rotation; the motor can be provided in a member on the proximal side of the joint and be connected to a member on the distal side thereof, or vice versa. In the robot arm of FIG. 2, joints 5₁, 5₂, 5₃ have their motors in members on their proximal side, i.e. in base 3 and links 4₁, 4₅, respectively; joints 5₃, 5₄ and 5₅ have the motors on their distal side, in links 4₃, 4₄ and 4₅, respectively.

Motors 92, 93, 94 associated to joints 5₂, 5₃, 5₄ and reduction gears 10₂, 10₃, 10₄ connecting these motors to links 4₂, 4₂ and 4₃, respectively, are shown in FIG. 1. A resolver 8ⱼ is placed at each joint 5ⱼ to measure its rotation angle q_{arm,j}*.

The reduction gear 10ⱼ is a harmonic gear, shown in the cross section in FIG. 3, in which a wave generator 16 is rigidly coupled to an output shaft 17 of motor 9ⱼ, and is pressing teeth of a flex spline 18 into local engagement with a circular spline 19 surrounding it. When the number of teeth of the circular spline 19 is i_{c} and that of the flexspline 18 is i_{f}, the nominal transmission ratio of the gear 10ⱼ is

$${R}_{j} = \frac{{i}_{f} - {i}_{c}}{{i}_{f}} .$$

Since the flex spline is 18 rotating in a direction opposite that of the wave generator 16, points of the two currently in contact will meet again after the wave generator 16 has rotated by 2πi_{f}/i_{c}, slightly less than a complete turn.

The link 4₆ at the distal end of the robot arm 1 carries an optical sensor portion 20 of an optical flow sensor 22. A signal processor 21 for extracting the optical flow from the output of the optical sensor portion 20 can be integrated in the optical sensor portion 20 itself, or controller 2. As shown here, the optical sensor portion 20 can be attached to a flange of link 4₆ which, in normal operation of the robot arm 1, would carry an end effector. The optical sensor portion 20 can be of a type commonly used in optical computer mice, designed to detect a displacement of the link 4₆ while being in sliding contact with the support 7. Alternatively, the end effector can be attached to the flange and hold the optical sensor portion 20.

According to a still further alternative, the optical sensor portion 20 might comprise an electronic camera, outputting a series of frames, and the signal processor for extracting the optical flow from the frames is implemented in controller 2. The camera can be attached to the link 4₆ as described above, or a dedicated connector for the camera could be provided on the link 4₆ in addition to the flange, or on link 4₅, so that in normal operation the camera can be attached to the robot arm 1 concurrently with the end effector and can be used to monitor operation of the end effector.

In a particular embodiment, the camera is part of a smartphone temporarily attached to the robot arm 1, e.g. being held by the end effector. In that case, the signal processor 21 for extracting the optical flow can be the processor which is conventionally built-into the smartphone, and which can be adapted to extract the optical flow by appropriate software loaded into a memory of the smartphone. Since many conventional smartphones come with an IMU, the software can be designed to consider output from the IMU when extracting the optical flow.

The support 7 can be provided with a grid or pattern 23, in order to facilitate quantitative detection of a displacement of the link 4₆ by the flow sensor 22.

To facilitate quantitative detection of a displacement, it is also helpful for the camera to be held with its optical axis perpendicular to the surface of the support 7 observed by it, so that the size of a feature on that surface will not vary while in images from the camera while the camera is moved parallel to the surface.

Controller 2 comprises a command generator 8 which receives a predetermined trajectory τ, defined by a plurality of points in three-dimensional space and associated instants in time at which a reference point of the link 4₆ or of the optical sensor portion 20 mounted to it is to reach each of these points. Based on a model of the robot arm 1, the command generator determines a series of rotation angles q_{mot,j} to be assumed by the motors 9ⱼ of the joints 5ⱼ in order to place the reference point at points of the predetermined trajectory τ and of motor speeds \dot{q}_{mot,j} needed in order to have the reference point move along the trajectory τ at a constant speed.

To calculate the position of the reference point in three-dimensional space from motor angles q_{mot,j}, the relation between each motor angle and the associated joint angle and the length of each link must be known. Ideally, the relation between motor and joint angles would simply be q_{arm,j}=Rⱼq_{mot,j}, and the length of each link should be equal to a rated value. When imperfections of the reduction gear 10ⱼ are taken into account, the relation can be written as

$${q}_{arm , j} = {R}_{j} {q}_{mot , j} + {ϑ}_{0} + {\sum }_{i = 1}^{M} {A}_{i , j} sin ( {k}_{i} {q}_{mot , j} + {ϑ}_{i , j} ) ,$$

wherein ϑ₀ is an offset between an angle measured by resolver 8; and the actual rotation angle of link 4ⱼ, A_{i,j} and ϑ_{i,j} are weighting coefficients and phases of harmonics caused by imperfections such as eccentricities of gearwheels in the reduction gear 10ⱼ, and ϑ₀+

$${\sum }_{i = 1}^{M} {A}_{i , j} sin ( {k}_{i} {q}_{mot , j} + {ϑ}_{i , j} )$$

is referred to as the kinematic error correction δq_{ke,j} of joint 4ⱼ. Based on the relation above, the model allows to calculate the position of the reference point as a function not only of the motor angles q_{mot,j}, but also of the intrinsic parameters A_{i,j}, ϑ_{i,j}, ϑ₀ that are characteristic for this particular robot arm 1.

It should be kept in mind that the above equation is an approximation, the precision of which varies depending on the number of summands M considered. In a simple but practically relevant case, M can be zero, i.e. the equation reduces to

$${q}_{arm , j} = {R}_{j} {q}_{mot , j} + {ϑ}_{0} .$$

This case will not be specifically described below, since it can be readily derived from any of the following mathematical expressions by setting M=0, or A_{i,j}, ϑ_{i,j}=0.

Trajectory generator 11 is adapted to output to joint controllers 12ⱼ associated to each joint 5ⱼ the series of position and speed commands q_{mot,j} \dot{q}_{mot,j} with an appropriate timing, as would be required for having a reference point follow the predetermined trajectory τ assuming that the resolver offset ϑ₀ is zero, and that the transmission ratio of each reduction gear 10ⱼ is the rated ratio and independent of the orientation of its associated motor output shaft 17ⱼ i.e. that all coefficients ϑ₀, A_{i,j} are zero.

Each joint controller 12ⱼ further has associated to it a kinematic error calculator 13ⱼ for calculating the kinematic error correction δq_{ke,j} and its derivative δ\dot{q}_{ke,j} and adders 14ⱼ, 15ⱼ for superimposing the kinematic error correction onto the commands q_{mot,j}, \dot{q}_{mot,j} output by the trajectory generator 11, and providing corrected commands \hat{q}_{mot,j}=q_{mot,j}+δq_{ke,j}, \hat{\dot{q}}_{mot,j}=\dot{q}_{mot,j}+δq_{ke,j} as will be explained in detail below.

It can be assumed that prior to calibration of the robot arm 1 by the method of the present invention, the kinematic error calculators 13ⱼ apply kinematic error corrections δqₖₑ, δ\dot{q}ₖₑ=0 for all joints.

In a first step of the method, the command generator calculates a series of commands {q_{mot,j}, \dot{q}_{mot,j}}₀ which would cause the reference point to follow the predetermined trajectory by moving along a predetermined path 24 at a constant speed under the assumption that the intrinsic parameters A_{i,j}, ϑ_{i,j}, ϑ₀ are all zero, and dimensions of the links equal their respective rated values.

While trajectory generator 11 outputs this series of commands {q_{mot,j}, \dot{q}_{mot,j}}₀, causing the reference point to move approximately along the path 24, the optical flow sensor 22 records fluctuations of the velocity vector.

In an elementary embodiment, the same series of commands {q_{mot,j}, \dot{q}_{mot,j}}₀ is output repeatedly, with different vectors of values of the intrinsic parameters being provided to the kinematic error calculators 13ⱼ, finally retaining the vector that minimized variation of the optical flow. Such an approach can be viable where the number of parameters to be optimized is small, when fluctuations of the transmission ratio are assumed to vanish for all joints, i.e. ϑ₀, A_{i,j}=0.

In a more systematic embodiment, controller 2 first calculates based on a path integral of these fluctuations a trajectory that was actually followed by the reference point.

When, at a given point in time moving along the trajectory τ, commands are such that the reference point should be located at a point r in space, but the actual position resulting from execution of the commands is r+ε, then it should be possible to place the reference point closer to r by issuing commands that would place it at r−ε, instead. Based on the original predetermined trajectory τ defining points r and the one actually followed and defining points r+ε, the controller 7 then calculates a corrected trajectory τ* formed of points r−ε and a series of corrected commands associated to the corrected trajectory τ*. Then it determines a vector of intrinsic parameters (A_{i,j}, ϑ_{i,j}, ϑ₀) so that when the trajectory generator outputs the original series of commands {q_{mot,j}, \dot{q}_{mot,j}}₀, kinematic error calculators 13ⱼ will add such a correction δqₖₑ, δ\dot{q}ₖₑ that commands \hat{q}_{mot,j}=q_{mot,j}+δqₖₑ, \hat{\dot{q}}_{mot,j}=\dot{q}_{mot,j}+δqₖₑ received by the joint controllers 12ⱼ approximate those associated to the corrected trajectory τ*.

Based on plain and simple guessing or on some more elaborate, conventional optimization algorithm, the controller determines a vector κ of values of the intrinsic parameters ϑ₀, and, if appropriate, A_{i,j}, ϑ_{i,j}, such that an improved trajectory predicted by the model based on this vector of values is closer to the corrected trajectory τ* than the original predetermined trajectory τ was. Different metrics can be used for quantifying closeness, e.g. an integral, taken along one of the trajectories τ*, τ, of the scalar distance between points associated to a same instant in time, of the two trajectories, or the maximum of the scalar distance over the two trajectories. This vector of values k is then input to the kinematic error calculators 13ⱼ, enabling these, while the trajectory generator 11 outputs the same series of commands {q_{mot,j}, \dot{q}_{mot,j}} as before a second time, to calculate, for each value of q_{mot,j}, \dot{q}_{mot,j} output by the trajectory generator, the appropriate kinematic error δq_{ke,j}. δ\dot{q}_{ke,j} as a function of q_{mot,j} so that the joint controllers 12ⱼ receive corrected commands \hat{q}_{mot,j}=q_{mot,j}+δqₖₑ, \hat{\dot{q}}_{mot,j}=\dot{q}_{mot,j}+δ\dot{q}ₖₑ. In this way, a vector of intrinsic parameters κ reasonably close to the true values can be obtained based on a single displacement of the reference point along the predeterminer trajectory.

If desired, intrinsic parameters still closer to the true values can be obtained by having the command generator calculates new series of commands {q_{mot,j}, \dot{q}_{mot,j}}_{κ} based on the vector of intrinsic parameters κ obtained previously, i.e. comprising those commands that would be required to have the reference point follow the predetermined trajectory if the intrinsic parameter values used in the model for determining the commands had been κ, not 0. Using this new series of commands {q_{mot,j}, \dot{q}_{mot,j} }_{κ} in place of {q_{mot,j}, \dot{q}_{mot,j}}₀ the above procedure can be repeated as often as needed to reduce the fluctuations of the velocity vector below a given limit.

The predetermined trajectory τ can be chosen so that in order to displace the reference point along its path, the robot arm 1 must move in all its degrees of freedom. In that case, the intrinsic parameters can be obtained concurrently for all joints 5ⱼ resp. all reduction gears 10ⱼ of the robot arm. However, the large number of parameters under consideration tends to make calculations lengthy and to increase the number of iterations needed to bring the fluctuations of the velocity vector below a given limit. In the case shown in FIG. 2, path 24 is chosen parallel to support surface 7 and straight in a direction so that it can be followed by moving only joints 5₂, 5₃ and 5₅ (hidden behind link 4₅), while keeping all others stationary. This greatly reduces the number of intrinsic parameters to be estimated. Paths that require only a subset of the joints to be moved are mostly straight or circular arcs.

Once intrinsic parameters have thus been determined for joints 5₂, 5₃ and 5₅, these can be regarded as known and no longer subject to optimization when intrinsic parameters for the remaining links are determined using a different predetermined path that requires a movement of one or more of the yet unexamined joints and of one or more of joints 5₂, 5₃ and 5₅. For example, a second predetermined path might be a path 25, perpendicular to path 24, on horizontal support 7. For the reference point to follow this path, joints 5₁, 5₆ must rotate in addition to joints 5₂, 5₃ and 5₅ so that, when following path 25 with intrinsic parameters for joints 5₂, 5₃ and 5₅ being known from having carried out the above method for path 24, parameters for joints 5₁, 5₆ are quite straightforward to find in spite of the large number of joints involved in the movement.

As an alternative, paths 26, 27 on a vertical surface, e.g. on a workshop wall next to the robot 1, might be used.

While conventional camera-based calibration methods require that relative positions of a reference point of the robot, a reference point of the working environment and of the camera be known with high precision for a reference pose of the robot, and inaccuracies in the measurement of each can affect the quality of calibration, there is no such requirement for the robot system of the present invention, so that a precise calibration can be achieved without much preparatory work.

The optical sensor portion could be stationary and be arranged to sense a displacement of the reference point by having the latter move through its detection range. Preferably, however, the optical sensor portion is arranged to sense displacement of the reference point by being mounted on a same link with said reference point and sensing a stationary surface, since then a single optical sensor portion can be sufficient for carrying out a calibration spanning the entire displacement range of the link, even if the detection range of the optical sensor portion is smaller than the displacement range.

Different types of optical flow sensor can be used for the invention. In a basic embodiment, an optical flow sensor of the type used in computer mice could be employed, and the movement of the sensor portion of the optical flow sensor might be in sliding contact with a surface of the robot's working environment. In a preferred embodiment, the optical flow sensor comprises a camera, and the evaluation portion is adapted to extract an optical flow from image data of the camera, since the camera might also be used for closed loop control of the robot, for example when the reference point must be positioned with respect to a workpiece whose position is variable.

Extracting the optical flow from image data is facilitated when the movement of the reference point is parallel to a surface that is being observed by the camera during said movement.

The surface observed can be any flat surface in the working environment of the robot, such as a floor or a wall of a room containing the robot, or a tabletop supporting the robot. Preferably the robot is mounted on said surface, since thus the orientation of the surface in a coordinate system in which a base of the robot is stationary is known, and the predetermined path can easily be controlled to be parallel to the surface.

In a coordinate system in which the sensor portion is stationary, the reference point should preferably be stationary, too. This can be achieved by attaching both to a same link, typically a distalmost link, of the robot.

Irregularities of the optical flow are the easier to detect, the more regular the predetermined path is. Preferably, therefore, the predetermined comprises at least one of a straight line, a circle or a circular arc. To allow calibration of various degrees of freedom of the robot, more than one of the above-defined paths can be combined, thus forming a composite path comprising e.g. a pair lines that meet under a predetermined angle, or several pairs forming a rectangle or a polygon.

At least one of the intrinsic parameters to be optimized in the calibration should relate to the length of one of said links (or, to be precise, the distance between axes of joints at the proximal and distal ends of said link), to an offset between a target rotation angle and an actual rotation angle of a joint, or to the transmission ratio of a reduction gear associated to one of said joints. Where the intrinsic parameter relates to the transmission ratio, it may define Fourier coefficients and phases of harmonic components of the rotation speed of an output shaft of the reduction gear when the input shaft is driven at a constant rotation speed.

The deviation to be minimized should be a difference amount integrated along said predetermined path, as such a deviation between an expected position or speed and a position or speed deduced from the optical flow will vanish when calibration is perfect.

The invention further provides a method for calibrating an articulated robot comprising a plurality of links connected to one another by rotary joints, the method comprising the steps of:
a) controlling movement of a reference point on one of said links along a predetermined path so that an expected position of the reference point calculated based on target rotation angles associated to the joints and on a vector of intrinsic parameters of the robot varies with a predetermined velocity,
b) simultaneously with step a), measuring the velocity of the reference point using an optical flow sensor,
c) comparing the velocity measured in step b) to said predetermined velocity;
and
d) minimizing a deviation between the measured and predetermined velocities by varying the vector of intrinsic parameters.

Step d) may comprise repeating steps a) to c) after having made a variation to the vector of intrinsic parameters, to determine the effect of the variation.

The amount and, optionally, the direction of the predetermined velocity can be held constant along at least part of the predetermined path, so that any variation of the amount or direction of the velocity derived from the optical flow can be regarded as a deviation which is to be minimized.

In order to reduce the time needed for the minimization, the method can comprise the steps of: simulating at least one data series of velocities expected along said path when the intrinsic parameter vector of the robot differs from a nominal parameter vector by a predetermined deviation vector, choosing the variation made in step d) based on a comparison of velocities measured in step b) with said at least one simulated data series. The more closely one of these data series resembles the result of measuring the velocity in step b), the more safely it can be assumed correcting the vector of intrinsic parameters by said predetermined deviation vector will reduce the deviation between measured and predetermined velocities.

The measurement of velocity in step b) can be facilitated by also taking into account output from an inertial measurement unit (IMU) which is moved jointly with at least the optical sensor portion of the flow sensor. Since many mobile phones come equipped with both a camera and an IMU, using such a mobile phone by e.g. temporarily attaching it to the robot arm can be a very convenient and economic way to carry out the calibration.

A further object of the invention is a computer program product comprising instructions which, when executed by a processor, cause the processor to operate as the controller in the robot system described above or to carry out the above method.

Further features and advantages of the invention will become apparent from the subsequent description of embodiments, referring to the appended drawings.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A robot system, comprising:
an articulated robot comprising a plurality of links connected to one another by rotary joints;
an optical flow sensor comprising an optical sensor portion arranged to sense displacement of one of the plurality of links, and an evaluation portion for deriving velocity information from image data output by the sensor portion; and
a controller configured to:
calculate an expected position of a reference point on one of the plurality of links based on rotation angles associated to the rotary joints and on a vector of intrinsic parameters of the articulated robot;
control movement of the reference point along a predetermined path so that the expected position varies with a predetermined velocity;
compare a velocity measured by the optical flow sensor during the movement to the predetermined velocity; and
minimize a deviation between the measured and predetermined velocities by varying the vector of intrinsic parameters.

2. The robot system of claim 1, wherein the optical sensor portion is arranged to sense displacement of the one of the plurality of links by being mounted on the particular link and being disposed to sense a stationary surface.

3. The robot system of claim 1, wherein the optical sensor portion is a camera, and the movement of the reference point is parallel to a surface that is being observed by the camera during said movement.

4. The robot system of claim 3, wherein during the movement an optical axis of the camera is controlled to be perpendicular to the surface.

5. The robot system of claim 3, wherein the surface is a floor or a wall of a room containing the articulated robot, or a surface on which the robot is mounted.

6. The robot system of claim 1, wherein in a coordinate system in which the sensor portion is stationary, an end effector of the robot is also stationary, optionally wherein the end effector and the sensor portion are attached to a distalmost one of said links.

7. The robot system of claim 1, wherein the predetermined path comprises at least one of a straight line, a circle, a circular arc, a pair of lines that meet under a predetermined angle, a rectangle, a polygon.

8. The robot system of claim 1, wherein at least one of the intrinsic parameters relates to an offset between a target rotation angle and an actual rotation angle of a joint.

9. A method for calibrating an articulated robot comprising a plurality of links connected to one another by rotary joints, the method comprising:
a) controlling movement of a reference point on one of the plurality of links along a predetermined path so that an expected position of the reference point calculated based on rotation angles associated to the joints and on a vector of intrinsic parameters of the robot varies with a predetermined velocity;
b) simultaneously with step a), measuring the velocity of the reference point using an optical flow sensor;
c) comparing the velocity measured in step b) to said predetermined velocity; and
d) minimizing a deviation between the measured and predetermined velocities by varying the vector of intrinsic parameters.

10. The method of claim 9, wherein step d) comprises repeating steps a) to c) after having made a variation to the vector of intrinsic parameters.

11. The method of claim 9, wherein the amount and the direction of the predetermined velocity is constant along at least part of the predetermined path.

12. The method of claim 11, wherein step c) comprises recording fluctuations of the amount and of the direction of the velocity measured in step b).

13. The method of claim 9, further comprising:
e) simulating at least one data series of velocities expected along said path when the intrinsic parameter vector of the robot differs from a nominal parameter vector by a predetermined deviation vector; and
f) choosing the variation made in step d) based on a comparison of velocities measured in step b) with said at least one simulated data series.

14. The method of claim 9, wherein in step b), measurement of the velocity is further based on IMU data.

15. The method of claim 9, wherein the method is computer implemented in a set of instructions that are stored on tangible computer media and are executed by computer to carry out steps of the method.
